(19) United States
(12) Patent Application Publication
(10) Pub. No.: US 2024/0330690 A1
(43) Pub. Date: Oct. 3, 2024

(54) POINT-OF-INTEREST RECOMMENDATION METHOD AND SYSTEM BASED ON BRAIN-INSPIRED SPATIOTEMPORAL PERCEPTUAL REPRESENTATION

(71) Applicant: ZHEJIANG UNIVERSITY, Hangzhou (CN)

(72) Inventors: Huajin Tang, Hangzhou (CN); Gehua Ma, Hangzhou (CN); Rui Yan, Hangzhou (CN)

(73) Assignee: ZHEJIANG UNIVERSITY, Hangzhou, ZJ (CN)

(21) Appl. No.: 17/756,849

(22) PCT Filed: Sep. 13, 2021
(86) PCT No.: PCT/CN2021/117879

§ 371 Date: Jun. 3, 2022

(30) Foreign Application Priority Data
Aug. 13, 2021 (CN) 202110930940.0

(51) Int. Cl. G06N 3/088; G06N 3/045

(52) U.S. Cl. CPC G06N 3/088; G06N 3/045

(57) ABSTRACT

A POI recommendation method and system based on brain-inspired spatiotemporal perceptual representation is provided. The method includes: constructing a POI context graph structure based on a POI check-in dataset; sampling a check-in sequence context graph, and training a POI check-in sequence embedding model in a brain-inspired spatiotemporal perceptual embedding model by unsupervised learning; sampling a spatial context graph and a spatiotemporal context graph to train a spatiotemporal embedding model in a brain-inspired spatiotemporal perceptual embedding model; combining a POI sequence representation vector and a POI spatiotemporal union representation vector into a POI spatiotemporal perceptual representation vector; training a recurrent neural network recommender based on the POI spatiotemporal perceptual representation vector; and recommending a next POI through the trained recurrent neural network recommender. By mining the spatiotemporal complexity and check-in sequences of POIs, the POI recommendation method and system enable efficient representation of POIs from multiple perspectives.

### CROSS REFERENCE TO RELATED APPLICATION

This application is the National Stage filing under 35 U.S.C. 371 of International Application No. PCT/CN2021/117879, filed Sep. 13, 2021, which claims priority of the Chinese Patent Application No. 202110930940.0, filed with the China National Intellectual Property Administration (CNIPA) on Aug. 13, 2021, and entitled “POINT-OF-INTEREST RECOMMENDATION METHOD AND SYSTEM BASED ON BRAIN-INSPIRED SPATIOTEMPORAL PERCEPTUAL REPRESENTATION”, Both of the aforementioned applications are hereby incorporated by reference in their entireties.

### TECHNICAL FIELD

The present disclosure relates to the technical field of artificial intelligence, and in particular, to a point-of-interest (POI) recommendation method and system based on brain-inspired spatiotemporal perceptual representation.

### BACKGROUND ART

With the rise of location-based networks, people have been sharing lots of tweets and comments with precise geographical location, which changes the way humans interact with the geographical environment and leads to a huge demand for POI recommendation. By taking into consideration the time dimension, the next POI can be precisely recommended by POI recommendation technology. This recommendation algorithm can mine POI-related information and provide users with a list of recommendation, so as to guide users to the next appropriate location, which is thus of great benefit to users and POI owners.

In recent years, researchers have developed a series of recommendation methods by mining big data related to POIs. Due to the high relevance of neighboring POIs in a check-in sequence, many researchers adopt sequence analysis models such as Markov Chain to model a user's POI check-in sequence, thereby achieving POI recommendation. However, the methods described above only regard POIs as a generalized sequence element without fully utilizing rich characteristics in themselves, which restricts the effect of recommendations. Most recommendation systems rely largely on user preferences in the modeling process. And for POI recommendation, highly accurate recommendations can be obtained through accurate portrayal of a user, provided that the user's check-in history is sufficient. However, there are two prominent problems in recommendations based on user portraits. First, recommendation effect in the case of cold start (Cold-start) cannot be guaranteed, that is, for a user with little or no check-in history, recommendation based on preferences is not reliable. Second, users' private data on personal preferences is now exposed to a risk of disclosure, which will lead to systematic ethical issues. Given the natural geospatial attributes in POIs, recommendations with considering spatial information can greatly improve the quality of recommendation. Lian et al. proposed adopting power-law distribution and normal distribution to describe the spatial distribution characteristics of POIs. Feng et al. depicted the geographical location characteristics of POIs through multi-level two-dimensional space partitioning. In these works, however, the geo-spatial information on POIs is understood based on experience, in fact, completely dependent on artificial priori settings. Further, these works only involve a single-scale representation of the local or global geographical distribution characteristics of POIs, making it hard to effectively describe the multi-scale spatial characteristics of POIs. As shown in a large amount of data analysis, the check-in time of POIs also presents diversity, and the time dimension characteristics of such POIs further assist decision recommendation. Based thereupon, the temporal and spatial characteristics of POIs are considered simultaneously. In some studies, a series of POI recommendation methods are proposed based on the analysis of spatial distance and check-in time interval of POIs. For example, Li, Nabitumruksa, Zhao et al. proposed an RNN (recurrent neural network)-based POI recommendation system which conducts modeling according to spatiotemporal transference. Despite this, these works use generalized time interval and spatial displacement in the process of considering the spatiotemporal characteristics of POIs, failing to fully mine the spatiotemporal characteristics of POIs for further recommendation. Besides, as some location-based social platforms can push text messages tagged with location, there are also researches in which text messages associated with POIs are used for the recommendation of next POI. However, such a method has some distinct limitations, such as a sharp reduction in recommendation performance in circumstances where text messages are unavailable.

### SUMMARY

An objective of the present disclosure is to provide a point-of-interest (POI) recommendation method and system based on brain-inspired spatiotemporal perceptual representation. By mining the spatiotemporal complexity and check-in sequence characteristics of the POIs, the brain-inspired spatiotemporal perceptual embedding model inspired by a cerebral entorhinal-hippocampal structure is used to efficiently represent the POIs from multiple perspectives.

The present disclosure provides the following technical solutions to achieve the above purpose.

A point-of-interest (POI) recommendation method based on brain-inspired spatiotemporal perceptual representation includes:
constructing a POI context graph structure based on a POI check-in dataset: where the POI context graph structure includes a check-in sequence context graph, a spatial context graph and a spatiotemporal context graph of POIs;
sampling the check-in sequence context graph to obtain a POI samples;
training a POI check-in sequence embedding model in a brain-inspired spatiotemporal perceptual embedding model based on the POI samples by unsupervised learning; where the POI check-in sequence embedding model is configured to extract a POI sequence representation vector;
sampling the spatial context graph and the spatiotemporal context graph to obtain spatial POI samples and spatiotemporal POI samples and generate a POI check-in time matrix;
training a spatiotemporal embedding model in the brain-inspired spatiotemporal perceptual embedding model based on the spatial POI samples, the spatiotemporal POI samples and the POI check-in time matrix by unsupervised learning: where the spatiotemporal embedding model is configured to extract a POI spatiotemporal union representation vector including a spatial embedding representation vector and a spatiotemporal embedding representation vector;
combining the POI sequence representation vector and the POI spatiotemporal union representation vector into a POI spatiotemporal perceptual representation vector; and
training, based on the POI spatiotemporal perceptual representation vector, a recurrent neural network recommender; and recommending a next POI through the trained recurrent neural network recommender.

Optionally, the constructing a POI context graph structure includes sorting check-in records of a user in a time sequence to determine a POI check-in sequence; and connecting neighboring POIs in the POI check-in sequence via edges to construct the check-in sequence context graph.

Optionally; spatially neighboring POIs are connected via edges to construct the spatial context graph, the spatially neighboring POIs are K POIs closest to a central POI.

Optionally, temporally neighboring POIs are connected via edges to construct the temporal context graph, the temporally neighboring POIs are spatially neighboring and have a similar check-in time pattern: for the POIs with the similar check-in time pattern, the number of neighboring check-in timestamp pairs is not less than a threshold value m; the neighboring check-in timestamp pairs are identical in an attribute about “workday or not”, and have a check-in moment less than a threshold value h.

Optionally, said training a spatiotemporal embedding model in the brain-inspired spatiotemporal perceptual embedding model based on the spatial POI samples, the spatiotemporal POI samples and the POI check-in time matrix by unsupervised learning specifically includes:
training a spatial embedding model based on the spatial POI samples; where the trained spatial embedding model is configured to extract spatial proportional POIs; and
training the spatiotemporal embedding model in the brain-inspired spatiotemporal perceptual embedding model based on the spatial proportional POIs, the spatiotemporal POI samples and the POI check-in time matrix by unsupervised learning.

Optionally; the generating a POI check-in time matrix includes:
filling POI check-in records in the spatiotemporal context graph into a null matrix by date and time so as to construct an initial POI check-in time matrix; and
performing normalization processing and convolution operation on the initial POI check-in time matrix to obtain the POI check-in time matrix.

A POI recommendation system based on brain-inspired spatiotemporal perceptual representation includes:
a POI context graph structure constructing module configured to construct a POI context structure based on a POI check-in dataset: where the POI context graph structure includes a check-in sequence context graph, a spatial context graph and a spatiotemporal context graph of POIs;
a first sampling module configured to sample the check-in sequence context graph to obtain a POI samples;
a first training module configured to train a POI check-in sequence embedding model in a brain-inspired spatiotemporal perceptual embedding model based on the POI samples by unsupervised learning; where the POI check-in sequence embedding model is configured to extract a POI sequence representation vector;
a second sampling module configured to perform sampling on the spatial context graph and the spatiotemporal context graph to obtain a spatial POI samples and a spatiotemporal POI samples and generate a POI check-in time matrix;
a second training module configured to train a spatiotemporal embedding model in the spatiotemporal perceptual embedding model based on the spatial POI samples, the spatiotemporal POI samples and the POI check-in time matrix by unsupervised learning; where the spatiotemporal embedding model is configured to extract a POI spatiotemporal union representation vector including a spatial embedding representation vector and a spatiotemporal embedding representation vector;
a combining module configured to combine the POI sequence representation vector and the POI spatiotemporal union representation vector into a POI spatiotemporal perceptual representation vector; and
a third training module configured to, training, based on the POI spatiotemporal perceptual representation vector, a recurrent neural network recommender; and to recommend a next POI through the trained recurrent neural network recommender.

In some embodiments, it is provided a POI recommendation system based on brain-inspired spatiotemporal perceptual representation, which includes a processor and a memory storing program codes, wherein the processor performs the stored program codes to implement the above method.

In some embodiments, it is provided a non-transitory computer-readable storage media storing program codes which can be executed by a processor to implement the above method.

According to the specific embodiments provided by the present disclosure, the present disclosure discloses the following technical effects:
(1) In the present disclosure, the spatiotemporal characteristics of POIs are utilized to acquire spatiotemporal perceptual representation with high discriminability, and POI recommendation under extreme conditions such as invasion of user privacy and cold start can be achieved. For the spatial characteristics of a POI itself, the method of the present disclosure adopts a spatial location encoder based on the cerebral entorhinal grid cell model to mine the multi-scale geographical distribution characteristics of the POI. For the temporal characteristic of the POI itself, the method adopts tensorization on the POI check-in time patterns and uses the temporal characteristic of the POI through the multi-level spatiotemporal POI coupling characteristic of neighboring check-in timestamps. POIs with similar check-in time patterns and spatiotemporal neighboring POIs.
(2) The method, based on the information representation and processing mechanism in the cerebral entorhinal-hippocampal loop, i.e., the chart representation and multi-perception joint representation mechanism, uses spatiotemporal perceptual embedding vectors to efficiently describe POIs, thereby realizing high-quality POI recommendations.
(3) By referring to a graph representation mechanism of the entorhinal-hippocampal cognitive structure and the method of word embedding in natural language processing, the present disclosure makes full use of the relation of spatiotemporal and sequential contexts of POIs themselves in the construction of context graphs from different perspectives and realization of unsupervised representation learning. Compared with the POI recommendation method using POI tags (such as types of POIs) or other POI-related information (such as tweets, comments), the method proposed by the present disclosure can acquire the check-in order, geographical location, and check-in time of POIs in a sequence in the process of data collection, without additional cost in data annotation (point of interest tags, text screening, etc.).

### BRIEF DESCRIPTION OF THE DRAWINGS

To describe the technical solutions in the embodiments of the present disclosure or in the prior art more clearly, the accompanying drawings required for the embodiments are briefly described below: Apparently, the accompanying drawings in the following descriptions show merely some embodiments of the present disclosure, and those of ordinary skill in the art may still derive other accompanying drawings from these accompanying drawings without creative efforts.

FIG. 1 is a flowchart of a POI recommendation method based on brain-inspired spatiotemporal perceptual representation according to embodiments of the present disclosure;

FIG. 2 is a schematic diagram of a POI recommendation method based on brain-inspired spatiotemporal perceptual representation according to embodiments of the present disclosure;

FIG. 3 is definition diagram regarding sequence contexts:

FIG. 4 is a spatial context graph; and

FIG. 5 is a schematic diagram illustrating tensorization on the POI check-in time patterns.

### DETAILED DESCRIPTION OF THE EMBODIMENTS

The technical solutions in the embodiments of the present disclosure will be described below clearly and completely regarding the accompanying drawings in the embodiments of the present disclosure. All other examples obtained by a person of ordinary skill in the art based on the examples of the present disclosure without creative efforts shall fall within the protection scope of the present disclosure.

In spite of various existing POI recommendation methods, there is still a lack of a good solution for POI recommendation based on the spatiotemporal characteristics of POIs.

The study of the entorhinal-hippocampal loop in the mammalian brain has enlightened the design of an efficient POI recommendation method. It has been proved that grid cells in the entorhinal cortex can provide efficient multi-scale spatial representation, and place cells in the hippocampus provide a joint representation of multi-perception information by encoding the coupling relation among a variety of single cognitive signals. With the ongoing in-depth study on the learning-representation mechanism in the entorhinal-hippocampal formation, researchers hold that the joint representation of different perceptual dimensions abstracted from the graph structure lays a basis of memory and cognition in the entorhinal-hippocampal formation. When the next POI is recommended, a large amount of POI-related information can be expressed through the graph structure for supporting POI representation learning: the spatial coding mode of grid cells can lay a foundation for spatial modeling of POIs. Furthermore, the joint representation pattern of multi-perception signals from location cells also gives an enlightenment on the utilization of the time dimensions characteristic of the POI itself.

In view of the shortcomings of existing methods, the present patent, enlightened by the mechanism of an entorhinal-hippocampal cognitive structure in the mammalian brain, proposes a POI recommendation method based on brain-inspired spatiotemporal perceptual representation. By mining the spatiotemporal complexity and check-in sequence characteristics of POIs. and using a brain-inspired spatiotemporal perceptual embedding model inspired by a cerebral entorhinal-hippocampal formation, efficient representation of POIs from multiple perspectives is achieved. The method, in conjunction with the context features of check-in sequences of POIs, spatial distribution features of POIs and spatiotemporal union features of POIs, conducts representation extraction by training corresponding neural network models through an unsupervised learning strategy featuring context graph construction, sampling and representation.

To make the above-mentioned objective, features, and advantages of the present disclosure clearer and more comprehensible, the present disclosure will be further described in detail below in conjunction with the accompanying drawings and specific embodiments.

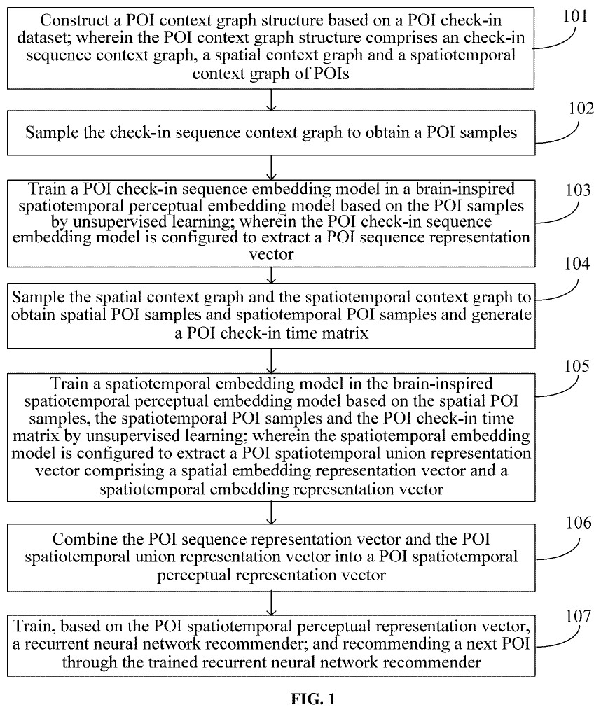

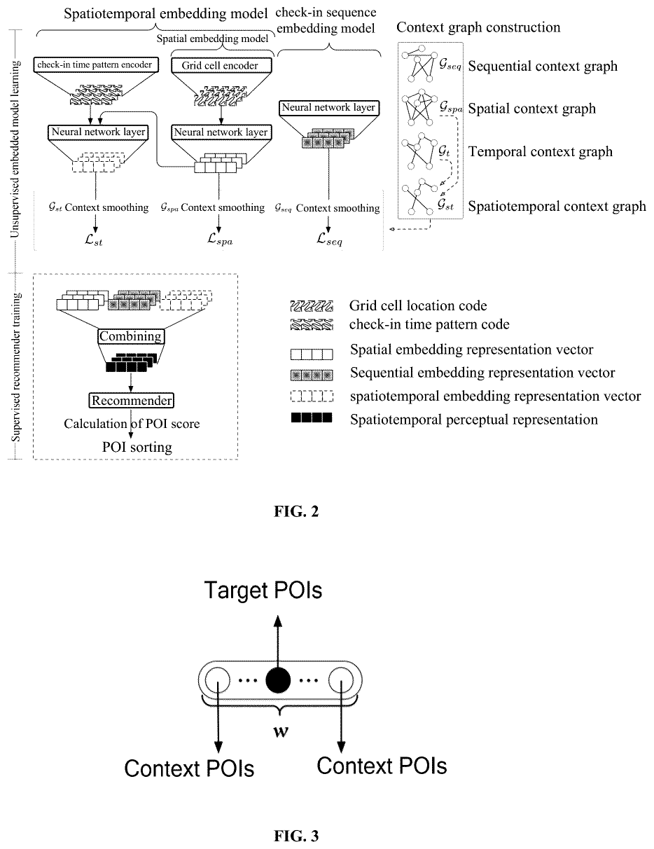

As shown in FIG. 1 and FIG. 2, a point-of-interest (POI) recommendation method based on brain-inspired spatiotemporal perceptual representation is as follows.

In step 101, a POI context graph structure is constructed based on a POI check-in dataset, and the POI context graph structure includes check-in sequence context graphs (also called sequential context graphs), spatial context graphs and spatiotemporal context graphs of POIs.

The POI check-in dataset used to construct context graphs can be a public dataset Gowalla or Instagram Check-in. The Gowalla dataset is collected from the location-based social game Gowalla via the data interface, and contains more than 6.44 million check-in records from 57436 POIs. and each record contains the geographic locations and check-in times of POIs. The Instagram Check-in dataset, collected from the well-known social network Instagram, includes more than 2.21 million check-in records from 13187 POIs, generated by 78233 users, each record in the dataset containing timestamps and additional tweets.

(1) The construction process of a check-in sequence context graph includes:
sorting check-in records of a user in a time sequence to determine a POI check-in sequence; and
connecting neighboring POIs in the POI check-in sequence via edges to construct the check-in sequence context graph.

For the original data about POI check-in, in the present disclosure, pre-processing is carried out to remove the outliers from the original data, that is, to screen out POIs visited less than 10 times and users with less than 10 check-in records. For each user number, check-in records of a certain user are selected and sorted in time order, so as to obtain a POI check-in sequence. A central POI (target POI) is selected in the POI check-in sequence, so that the sequence context (sequentially neighboring) POIs and the central POI are in the same sliding window. As shown in FIG. 3, the width W of the sliding window is an adjustable hyper-parameter, and the method of the present disclosure uses 2 (excluding the target POI) as the default value of the width of the sliding window: By connecting sequentially neighboring POIs via edges (Edge), a POI check-in sequence context graph is constructed, which is useful in subsequent training on a sequence embedding model.

(2) The construction process of a spatial context graph includes: connecting spatial neighboring POIs via edges to construct the spatial context graph, the spatially neighboring POIs being K POIs closest to a central POI.

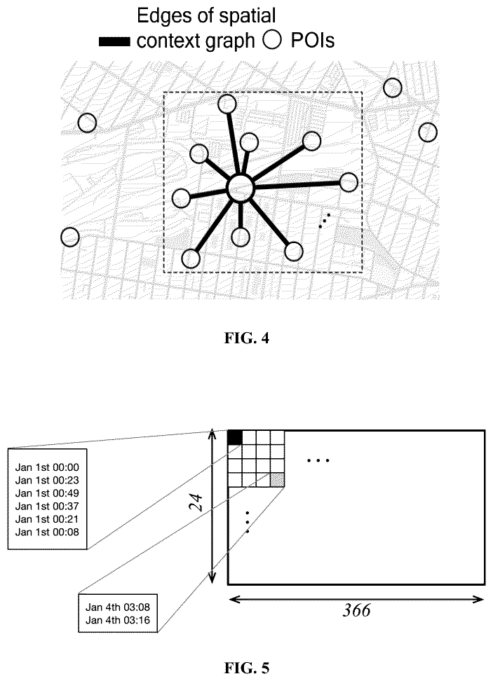

The process of constructing a spatial context graph is broadly divided into two steps, i.e., the coordinate transformation step and graph construction step, the graph construction step is schematically illustrated in FIG. 4. Since the geographical location is usually represented in the form of longitude and latitude, and the grid cell location encoder adopted in the method of the present disclosure takes the vector of two-dimensional Euclidean space as an input, the method adopts a general coordinate transformation mode to transform the latitude and longitude locations into two-dimensional Euclidean space coordinates. Specifically, latitude-longitude coordinates in a WGS84 geographic coordinate system are transformed into projection coordinates (two-dimensional space coordinates) in a NAD27 projection coordinate system. To define the spatial neighboring of POIs and appropriately simplify the spatial context graph, the method of determining spatial neighboring based on the distance between POIs is adopted in the present disclosure. For any POI, the K POIs closest thereto are defined as spatially neighboring POIs. and in the method of the present disclosure, the default value of K is set to 10. The spatially neighboring POIs are connected via edges to form a spatial context graph. All edges in the graph are equivalent, to avoid an excess of neighboring POIs (occurring in the dense region of POIs) or a lack of neighboring POIs (occurring in the sparse region of POIs) caused by adopting a threshold value to filter spatially neighboring POIs, thus ensuring the balance of the number of edges of POIs in the graph. Further, since the method of the present disclosure adopts a grid cell encoder which can effectively describe the characteristics of multi-scale spatial distribution. POIs sorted by distance and selected are similar to target POIs while retaining the characteristics of multi-scale spatial distribution. In this way, it is more convenient to obtain more efficient spatial embedding representation of POIs, and in turn construct efficient spatiotemporal perceptual representation.

(3) The construction process of a temporal context graph includes: connecting temporally neighboring POIs via edges to construct the temporal context graph. The temporally neighboring POIs are spatially neighboring and having a similar check-in time pattern, and for the POIs with a similar check-in time pattern, the number of neighboring check-in timestamp pairs is not less than a threshold value m. The neighboring check-in timestamp pairs are identical in the attribute “workday or not”, and each have a check-in moment less than a threshold value h.

The construction of the spatiotemporal context graph is intended for making use of the characteristics of check-in time patterns via spatiotemporal union features of POIs. Direct processing on POI check-in time patterns is infeasible, since for the recommendation of the next POI, there is no direct link between the similarity of the check-in time pattern and the likelihood that a POI is visited, and POIs with similar check-in time patterns may be far apart from each other. In addition, as single POI has a large amount of check-in records, direct traversing these records and constructing graphs will give rise to very high computing costs. By exploiting the characteristics of POI check-in time patterns via spatiotemporal union features, the preconditions of spatial neighboring are added in the process of determining the similarity of the check-in time of POIs, which greatly reduces the number of candidate POIs. Meanwhile, on the basis of spatial neighboring. POIs with similar check-in time patterns possess a higher potential of being visited, which lays a basis for defining an effective neighbor relation, making it possible to achieve learning of an embedding model based on this graph.

The present disclosure adopts the following method for constructing a spatiotemporal context graph of the POI. Firstly, the method of the present disclosure makes a definition on the neighboring check-in timestamps based on the timestamp interval (by hour) and the timestamp attribute (workday or not): the neighboring timestamps have the same attribute, and the timestamp interval is less than the threshold h hours, where the default value of h is set to 2. On the basis of definition of the neighboring check-in timestamps, for POIs with a similar check-in time pattern (Temporal Neighboring POIs), the number of neighboring check-in timestamp pairs is not less than a threshold value m, where the default value of m is set to 11. On this basis, the method of the present disclosure defines spatiotemporal neighboring POIs, i.e., spatially neighboring POIs with similar check-in time patterns.

In step 102, the check-in sequence context graphs are sampled to obtain POI samples.

In step 103, a POI check-in sequence embedding model in a brain-inspired spatiotemporal perceptual embedding model is trained based on the POI samples by unsupervised learning: where the POI check-in sequence embedding model is configured to extract a POI sequence representation vector.

For a given target POI and the POI check-in sequence thereof, the learning of the check-in sequence embedding model is aimed at correctly predicting true (Ground Truth) context POIs (sequentially neighboring POIs). This process ensures that during the update of the check-in sequence embedding model, the distance between POIs with a similar context in the embedding feature space will continue to narrow; highlighting the characteristics from the perspective of the POI check-in sequence. The method of the present disclosure acquires positive POI pairs (with edges directly connected in the graph) and negative POI pairs (without edges directly connected in the graph) based on graph sampling to calculate the objective function for updating initialized POI check-in sequence embedding model, the objective function being defined as follows:

$$O = {max}_{{p}_{i} ∈ {𝒫}_{ctx}^{j}} Pr ( {emb}_{seq}^{i} \vert {emb}_{seq}^{j} ) ,$$

where, O denotes the maximum likelihood target of the check-in sequence embedding model, emb_{seq}ⁱ denotes the sequential embedding representation vector of the POI i, and emb_{seq}^{j} denotes the sequential embedding representation vector of the POI j, the superscripts and subscripts of the latter two denote the sequence number of POIs and the type of embedding representation, respectively: pⱼ denotes the target POI j; and [symbol] denotes the set of neighboring POIs of the target POI j in the same sequence. Similar goals are often used in the task of element embedding, especially word or phrase embedding. Regarding any target POI, the space composed of negative samples thereof is infinite. The method of noise contrastive estimation is usually adopted to construct well-balanced positive and negative pairs for calculation of an objective function applicable to model updating. The function, by using negative sampling, is intended for extracting a batch of non-neighboring POIs for the target POI.

$$= - {\sum }_{{p}_{i} , {p}_{j} ∈ 𝒫} ( ( γ = 1 ) log σ ( {emb}_{seq}^{j} \cdot {emb}_{seq}^{i} ) + ( γ = - 1 ) log σ ( - {emb}_{seq}^{j} \cdot {emb}_{seq}^{i} ) )$$

where, [symbol] denotes the loss function configured to update the check-in sequence embedding model, where [symbol] is a symbolic function, when the POIs i, j are sequentially neighboring, γ is taken as 1, when the POIs i, j are not sequentially neighboring, γ is taken as −1, and γ indicates whether POIs pⱼ and pᵢ are sequentially neighboring or not; and POIs pᵢ, pⱼ are extracted from the set [symbol] of all POIs.

In step 104, sampling is conducted on the spatial context graphs and the spatiotemporal context graphs to obtain a spatial POI samples and a spatiotemporal POI samples and generate a POI check-in time matrix.

In step 105, a spatiotemporal embedding model in the brain-inspired spatiotemporal perceptual embedding model is trained based on the spatial POI sample, the spatiotemporal POI sample and the POI check-in time matrix by unsupervised learning: where the spatiotemporal embedding model is used for extracting a POI spatiotemporal union representation vector including a spatial embedding representation vector and a spatiotemporal embedding representation vector.

Specifically, a spatial embedding model is trained based on the spatial POI samples, the trained spatial embedding model is configured to extract spatial proportional POIs: the spatiotemporal embedding model in the brain-inspired spatiotemporal perceptual embedding model is trained based on the spatial proportional POIs, the spatiotemporal POI samples and the POI check-in time matrix by unsupervised learning.

### (1) Extraction of Spatial Embedding Representation of POIs Based on a Spatial Context Graph.

The method of the present disclosure adopts the spatial embedding model based on the grid cell encoder to update the model weight in the manner of spatial context graph sampling, and to extract the spatial embedding representation of the POIs. The grid encoder gₛₚₐ (pᵢ) encodes the coordinates pᵢ=(xᵢ, yᵢ)∈ [symbol] of the two-dimensional space into vector ψᵢ∈ [symbol] in the multi-scale geographic information representation space, and the process can be expressed as follows:

$${ψ}_{i} = [ {ψ}^{1} , {ψ}^{2} , … , {ψ}^{S} ]$$

where, the superscript of ψ denotes the scale sequence number, and a grid cell location code of a single two-dimensional spatial coordinate pᵢ=(xᵢ, yᵢ) is composed by S groups of location codes of different scales, which is a hyper-parameter denoting the number of scales, where the default value in the method of the present disclosure is set to 64. The location codes are calculated as follows:

$${ψ}_{i}^{s} = [ cos ( \frac{𝓋 \cdot {𝒶}_{k}}{{ρλ}_{min}} ) , sin ( \frac{𝓋 \cdot {𝒶}_{k}}{{ρλ}_{min}} ) ] , k = 1 , 2 , 3$$

where, ρ denotes the scale control coefficient: ψᵢ^{s} denotes the location code on the scale s, ν=[xᵢ, yᵢ] T denotes the location vector of pᵢ, and aₖ denotes a base vector for the grid cell firing pattern, specifically:

$$\{ \begin{matrix}{𝒶}_{1} = {[ 1 , 0 ]}^{T} \\ {𝒶}_{2} = {[ - \frac{1}{2} , \frac{\sqrt{3}}{2} ]}^{T} \\ {𝒶}_{3} = {[ - \frac{1}{2} , - \frac{\sqrt{3}}{2} ]}^{T}\end{matrix}$$

denote three isotropous unit base vectors for the grid cell firing pattern (Grid-cell Firing Pattern). ρ=λₘₐₓ/λₘᵢₙ, and λₘᵢₙ, λₘₐₓ denote the maximum and minimum scale parameters, respectively, the default values of λₘᵢₙ, λₘₐₓ is set to λₘᵢₙ=100 m, λₘₐₓ=1 km in the method, and the scale parameters may also be adjusted based on a specific condition. Given a target POI, the objective of the POI space embedding model is to maximize the probability of observing the real spatial context POIs, that is, the spatially neighboring POIs. The objective function of this unsupervised learning based on spatial context graph sampling is as follows:

$${ℒ}_{spa} = - {\sum }_{{p}_{i} ∈ 𝒫} {\sum }_{{p}_{j} ∈ {𝒫}_{spa}^{i}} ( log σ ( {emb}_{spa}^{j} \cdot {emb}_{spa}^{i} ) + \frac{1}{K} {\sum }_{{p}_{k} ∈ {𝒫}_{spa}^{- i}} log σ ( - {emb}_{spa}^{k} \cdot {emb}_{spa}^{i} ) )$$

where, [symbol] ₛₚₐ denotes the objective function of unsupervised learning based on spatial context graph sampling: σ is a sigmoid function, [symbol] denotes a set of POIs directly connected with pᵢ via edges in the spatial context graph, [symbol] denotes a set of POIs not directly connected with pᵢ via edges, and K is the number of negatives randomly selected, which is set to be 16 by default in the method of the present disclosure. pᵢ denotes the POI i, embₛₚₐⁱ denotes the POI space embedding vector of pᵢ, embⁱₛₚₐ denotes the POI space embedding vector of pⱼ, and emb^{k}ₛₚₐ denotes the POI space embedding vector of pₖ.

### (2) Extraction of Spatiotemporal Embedding Representation of POIs Based on a Spatiotemporal Context Graph.

The method according to the present disclosure utilizes the check-in time characteristics of the POIs themselves by use of constructing, sampling, and embedding of a spatiotemporal context graph, and on the basis of mining the geo-spatial characteristics of POIs. The spatiotemporal neighboring relationship among POIs as defined by the method of the present disclosure indicates the spatial proximity of the geographical locations of POIs, and the similarity of POI check-in time patterns is taken into account, which can provide highly reliable suggestions on POI check-in. However, the check-in record timestamps of POIs constitute a set, which cannot be used as a direct input to the spatiotemporal embedding model. In order to solve this problem, the present disclosure provides a method for coding POI check-in time patterns, which conducts tensorization on the discrete POI check-in record timestamps into a matrix with a fixed size. According to data analysis, the diversity of POI check-in time patterns mainly comes from diurnal variation (hourly scale), workday rule (daily scale) and seasonal variation (monthly and daily scale), but is not sensitive to annual scale. Therefore. POI check-in records are filled in a null matrix of 24×366 by date and time, so as to construct a POI check-in time statistical matrix. The matrix is represented as a thermal image with a pixel of 24×366, and the higher the check-in frequency is, the greater pixel value and darker color a time grid has, as shown in FIG. 5. In order to avoid the influence caused by the number of check-in records of different POIs, the method of the present disclosure performs max-min normalization on the original POI check-in time statistical matrix so that matrix elements fall into a range from 0 to 1. Upon normalization, a standard Gaussian window with the size of 3×3 is used to conduct convolution on the whole matrix, such that the pixel grids around the original pixel are assigned with different values according to the distance from the central pixel. By this operation, check-in records are augmented for POIs with fewer check-in records in a reasonable manner, and further the variance of the final POI check-in time pattern matrix is reduced, such that the sparsity of the whole matrix is reduced, which is conducive to the acquisition of robust model parameters by the POI spatiotemporal embedding model that receives the matrix as an input.

The POI spatiotemporal embedding model in the method of the present disclosure acquires positive/negative sample pairs in the way of spatiotemporal context graph sampling and calculates the objective function for updating model parameters, and the objective function calculated based on the spatiotemporal neighboring relationship is recorded as

$${st}_{} = - {\sum }_{{p}_{i} ∈ 𝒫} {\sum }_{{p}_{j} ∈ {𝒫}_{st}^{i}} ( log σ ( {emb}_{st}^{j} \cdot {emb}_{st}^{i} ) + \frac{1}{K} {\sum }_{{p}_{k} ∈} log σ ( - {emb}_{st}^{k} \cdot {emb}_{st}^{i} ) ) + {λ}_{spa} {spa}_{}$$

where, [symbol] ₛₜ denotes the objective function calculated depending on a spatiotemporal neighboring relationship; σ is a sigmoid function, [symbol] denotes the set of POIs in a spatiotemporal neighboring relationship with pᵢ, [symbol] denotes the set of POIs not in a spatiotemporal neighboring relationship with pᵢ, and K is the number of negatives randomly selected, which is set to be 16 by default. pᵢ denotes the POI i, embₛₜⁱ denotes the POI spatiotemporal embedding vector of pᵢ, embⁱₛₜ denotes the POI spatiotemporal embedding vector of pⱼ, emb^{k}ₛₜ denotes the POI spatiotemporal embedding vector of pₖ, and λₛₚₐ denotes a smoothing factor of a neighboring objective function of a balancing space. In the process of optimizing the POI spatiotemporal embedding model, the model parameters are updated according to the objective function calculated based on spatiotemporal neighboring and spatial neighboring, such that the optimization of the model can benefit from the rich context information of spatiotemporal context graphs and spatial context graphs.

In step 106, the POI sequence representation vector and the POI spatiotemporal union representation vector are combined into a POI spatiotemporal perceptual representation vector.

In step 107, based on the POI spatiotemporal perceptual representation vector, a recurrent neural network recommender is trained; and the next POI is recommended through the trained recurrent neural network recommender.

The representations obtained by the POI sequence embedding model and the spatiotemporal embedding model are combined into the POI spatiotemporal perceptual representation, and POI check-in sequences without annotations are used to train the recurrent neural network recommender. Based on the POI brain-inspired spatiotemporal perceptual embedding model including the POI check-in sequence embedding model and the spatiotemporal embedding model, the method of the present disclosure adopts a recurrent neural network composed of long-short term memory cell to recommend the next POI. Given the n POIs recently visited by a user (n=1 by default), in the method of the present disclosure, a spatiotemporal perceptual embedding vector is correspondingly selected from a spatiotemporal perceptual embedding vector table as an input of the recommender model, and a predicted spatiotemporal perceptual embedding vector [symbol] is output to indicate that a certain POI is recommended.

$$= ℯ𝒸ℴ𝓂𝓂ℯ𝓃𝒹ℯ𝓇 ( {\underbrace{{emb}_{step}^{1} , …}}_{n - 1} ) .$$

The goal of the recommender is to minimize the cosine distance between the recommended predicted POI spatiotemporal perceptual embedding vector and the spatiotemporal perceptual embedding vector of the ground truth POI, that is, to maximize the normalization probability of recommendation of correct POIs, and the objective function is expressed as:

$${pred}_{} = - {\sum }_{s ∈ 𝒮} log \frac{exp ( {σ}^{′} ( {emb}_{step}^{gt} \cdot / ‖ {emb}_{step}^{gt} ‖ \cdot ‖ ‖ ) )}{{\sum }_{{p}_{i} ∈ 𝒫} exp ( {σ}^{′} ( {emb}_{step}^{i} \cdot / ‖ {emb}_{step}^{i} ‖ \cdot ‖ ‖ ) )}$$

where [symbol] _{pred} denotes the objective function configured to update the recommender model, pᵢ denotes POI i, embₛₜₑₚⁱ denotes POI spatiotemporal perceptual representation vector of pᵢ, embₛₜₑₚ^{gt} denotes the spatiotemporal perceptual representation vector of the ground truth POI, σ′ is a nonlinear unit LeakyReLU, s represents a single check-in sequence, and [symbol] is a set of all orientation sequences. In the training process, the recommender model is updated through back propagation based on the objective function: in the reasoning process, the method of the present disclosure uses the recommender to obtain the cosine distance between a spatiotemporal perceptual embedding vector of a predicted POI and a spatiotemporal perceptual embedding vector of a candidate POI, and to generate a recommendation list through distance sorting.

The present disclosure further provides a POI recommendation system based on brain-inspired spatiotemporal perceptual representation, including:
a POI context graph structure constructing module configured to construct a POI context structure based on a POI check-in dataset: where the POI context graph structure includes a check-in sequence context graph, a spatial context graph and a spatiotemporal context graph of POIs;
a first sampling module configured to sample the check-in sequence context graph to obtain POI samples;
a first training module configured to train a POI check-in sequence embedding model in a brain-inspired spatiotemporal perceptual embedding model based on the POI sample by unsupervised learning; where the POI check-in sequence embedding model is configured to extract a POI sequence representation vector;
a second sampling module configured to perform sampling on the spatial context graph and the spatiotemporal context graph to obtain spatial POI samples and spatiotemporal POI samples and generate a POI check-in time matrix;
a second training module configured to train a spatiotemporal embedding model in the brain-inspired spatiotemporal perceptual embedding model based on the spatial POI samples, the spatiotemporal POI samples and the POI check-in time matrix by unsupervised learning; where the spatiotemporal embedding model is used for extracting a POI spatiotemporal union representation vector including a spatial embedding representation vector and a spatiotemporal embedding representation vector;
a combining module configured to combine the POI sequence representation vector and the POI spatiotemporal union representation vector into a POI spatiotemporal perceptual representation vector; and
a third training module configured to, training, based on the POI spatiotemporal perceptual representation vector, a recurrent neural network recommender; and to recommend a next POI through the trained recurrent neural network recommender.

The present disclosure has the following advantages:

### (1) Privacy Security

The conventional POI recommendation method is dependent upon the process of user preference modeling, which is a process involving a persona that may pose a security risk to user privacy. According to the POI recommendation method based on brain-inspired spatiotemporal perceptual representation in the present disclosure, the spatiotemporal characteristics of POIs are made full use of to acquire spatiotemporal perceptual representation with high discriminability, and POI recommendation in the absence of extreme conditions such as invasion of user privacy and cold start can be achieved. For the spatial characteristics of a POI itself, the method of the present disclosure adopts a spatial location encoder based on the cerebral entorhinal grid cell model to mine the multi-scale geographical distribution characteristics of the POI. For the temporal characteristic of the POI itself, the method adopts tensoriztion on the POI check-in time patterns, and uses the temporal characteristic of POI through the multi-level spatiotemporal POI coupling characteristic of neighboring check-in timestamps, POIs with similar check-in time patterns and spatiotemporal neighboring POIs.

### (2) Efficiency and Robustness

The method, based on the information representation and processing mechanism in the cerebral entorhinal-hippocampal loop, uses spatiotemporal perceptual embedding vectors to efficiently describe POIs, thereby realizing high-quality POI recommendation. The contrast of the method of the present disclosure with several high-performance POI recommendation methods on Instagram check-in dataset (Embodiment 1) and Gowalla dataset (Embodiment 2) can be found in Table 1 and Table 2.

TABLE 1
POI recommendation performance on Instagram check-in

| | Performance index | | | |
|---|---|---|---|---|
| Method | HIT@1 | HIT@5 | HIT@10 | MRR |
| Based on random generation representation [1] | 0.1207 | 0.2225 | 0.2751 | 0.1805 |
| Based on Skip-gram representation [2] | 0.1318 | 0.2344 | 0.2984 | 0.1875 |
| Based on CAPE representation [3] | 0.1381 | 0.2412 | 0.3054 | 0.1939 |
| ST-RNN[4] | 0.1054 | 0.2019 | 0.2426 | 0.1681 |
| LSTPM[6] | 0.1261 | 0.2134 | 0.3121 | 0.1957 |
| Embodiment 1: based on spatiotemporal perceptual | 0.2454 | 0.3204 | 0.3556 | 0.2835 |
| representation | | | | |

TABLE 2
POI recommendation performance on Gowalla Performance index

| | Performance index | | | |
|---|---|---|---|---|
| Method | HIT@1 | HIT@5 | HIT@10 | MRR |
| Based on random generation representation [1] | 0.0722 | 0.0736 | 0.0749 | 0.0737 |
| Based on Skip-gram representation [2] | 0.1085 | 0.2101 | 0.2585 | 0.1594 |
| ST-RNN[4] | 0.0519 | 0.0953 | 0.1304 | 0.2187 |
| STGN[5] | 0.0256 | 0.0784 | 0.1144 | 0.0590 |
| STGCN[5] | 0.0424 | 0.1134 | 0.1625 | 0.0842 |
| LSTPM[6] | 0.1468 | 0.2506 | 0.2983 | 0.1998 |
| STP-DGAT[7] | 0.1344 | 0.2414 | 0.2653 | 0.1856 |
| STP-UDGAT[7] | 0.1475 | 0.2911 | 0.3285 | 0.2130 |
| Embodiment 2: based on spatiotemporal perceptual | 0.1539 | 0.2968 | 0.3728 | 0.2282 |
| representation | | | | |

Where, Comparative Example [2]: Xin Liu, Yong Liu, and Xiaoli Li. Exploring the Context of Locations for Personalized Location Recommendations. In Proceedings of the International Joint Conference on Artificial Intelligence, pages 1188-1194, 2016.

Comparative Example [3]: Buru Chang, Yonggyu Park, Donghyeon Park, Seongsoon Kim, and Jaewoo Kang. Content-aware hierarchical point-of-interest embedding model for successive POI recommendation. In Proceedings of the International Joint Conference on Artificial Intelligence, pages 3301-3307, 2018.

Comparative Example [4]: Qiang Liu, Shu Wu, Liang Wang, and Tieniu Tan. Predicting the next location: A recurrent model with spatial and temporal contexts. In Proceedings of the AAAI Conference on Artificial Intelligence, pages 194-200, 2016.

Comparative Example [5]: Pengpeng Zhao, Haifeng Zhu, Yanchi Liu, Jiajie Xu, Zhixu Li, Fuzhen Zhuang, Victor S Sheng, and Xiaofang Zhou. Where to Go Next: A Spatio-Temporal Gated Network for Next POI Recommendation. In Proceedings of the AAAI Conference on Artificial Intelligence, 2019.

Comparative Example [6]: Ke Sun, Tieyun Qian, Tong Chen, Yile Liang, Quoc Viet Hung Nguyen, and Hongzhi Yin. Where to Go Next: Modeling Long- and Short-Term User Preferences for Point-of-Interest Recommendation. In Proceedings of the AAAI Conference on Artificial Intelligence, pages 214-221, 2020.

Comparative Example [7]: Nicholas Lim, Bryan Hooi, and Xueou Wang. STP-UDGAT: Spatial-Temporal-Preference User Dimensional Graph Attention Network for Next POI Recommendation. In Proceedings of the ACM International Conference on Information & Knowledge Management, pages 845-854, 2020.

### (3) Low Cost in Data Annotation

By referring to a graph representation mechanism of the entorhinal-hippocampal cognitive structure and the word embedding technology of natural language processing, the present disclosure makes full use of the relation of spatiotemporal and sequential contexts of POIs themselves, to construct the context graphs from different perspectives and realize unsupervised representation learning. Compared with the recommendation method using POI tags (such as types of POIs) or other POI-related information (such as tweets, comments), the method proposed by the present disclosure can acquire the check-in order, geographical location, and check-in time of POIs in a used sequence during date collection, without additional cost in data annotation (POI tagging, text filtering, etc.).

Each example of the present specification is described in a progressive manner, each example focuses on the difference from other examples, and the same and similar parts between the examples may refer to each other. Since the system disclosed in an embodiment corresponds to the method disclosed in another embodiment, the description is relatively simple, and reference can be made to the method description.

Specific examples are used herein to explain the principles and embodiments of the present disclosure. The foregoing description of the embodiments is merely intended to help understand the method of the present disclosure and its core ideas: besides, various modifications may be made by a person of ordinary skill in the art to specific embodiments and the scope of application in accordance with the ideas of the present disclosure. In conclusion, the content of the present description shall not be construed as limitations to the present disclosure.

1. A point-of-interest (POI) recommendation method based on brain-inspired spatiotemporal perceptual representation, comprising:
constructing a POI context graph structure based on a POI check-in dataset; wherein the POI context graph structure comprises a check-in sequence context graph, a spatial context graph and a spatiotemporal context graph of POIS;
sampling the check-in sequence context graph to obtain POI samples;
training a POI check-in sequence embedding model in a brain-inspired spatiotemporal perceptual embedding model based on the POI samples by unsupervised learning; wherein the POI check-in sequence embedding model is configured to extract a POI sequence representation vector;
sampling the spatial context graph and the spatiotemporal context graph to obtain spatial POI samples and spatiotemporal POI samples and generate a POI check-in time matrix;
training a spatiotemporal embedding model in the brain-inspired spatiotemporal perceptual embedding model based on the spatial POI samples, the spatiotemporal POI samples and the POI check-in time matrix by unsupervised learning; wherein the spatiotemporal embedding model is configured to extract a POI spatiotemporal union representation vector comprising a spatial embedding representation vector and a spatiotemporal embedding representation vector;
combining the POI sequence representation vector and the POI spatiotemporal union representation vector into a POI spatiotemporal perceptual representation vector; and
training, based on the POI spatiotemporal perceptual representation vector, a recurrent neural network recommender; and recommending a next POI through the trained recurrent neural network recommender.

2. The POI recommendation method based on brain-inspired spatiotemporal perceptual representation according to claim 1, wherein the constructing a POI context graph structure comprises:
sorting check-in records of a user in a time sequence to determine a POI check-in sequence; and
connecting neighboring POIs in the POI check-in sequence via edges to construct the check-in sequence context graph.

3. The POI recommendation method based on brain-inspired spatiotemporal perceptual representation according to claim 1, wherein spatially neighboring POIs are connected via edges to construct the spatial context graph, the spatially neighboring POIs are K POIs closest to a central POI.

4. The POI recommendation method based on brain-inspired spatiotemporal perceptual representation according to claim 3, wherein temporally neighboring POIs are connected via edges to construct a temporal context graph, the temporally neighboring POIs are spatially neighboring and have a similar check-in time pattern; for the POIs with the similar check-in time pattern, a number of neighboring check-in timestamp pairs is not less than a threshold value m; the neighboring check-in timestamp pairs are identical in an attribute about “workday or not”, and have a check-in moment less than a threshold value h.

5. The POI recommendation method based on brain-inspired spatiotemporal perceptual representation according to claim 1, wherein said training a spatiotemporal embedding model in the brain-inspired spatiotemporal perceptual embedding model based on the spatial POI samples, the spatiotemporal POI samples and the POI check-in time matrix by unsupervised learning comprises:
training a spatial embedding model based on the spatial POI samples; wherein the trained spatial embedding model is configured to extract spatial proportional POIs; and
training the spatiotemporal embedding model in the brain-inspired spatiotemporal perceptual embedding model based on the spatial proportional POIs, the spatiotemporal POI samples and the POI check-in time matrix by unsupervised learning.

6. The POI recommendation method based on brain-inspired spatiotemporal perceptual representation according to claim 1, wherein the generating a POI check-in time matrix comprises:
filling POI check-in records in the spatiotemporal context graph into a null matrix by date and time so as to construct an initial POI check-in time matrix; and
performing normalization processing and convolution operation on the initial POI check-in time matrix to obtain the POI check-in time matrix.

7. A POI recommendation system based on brain-inspired spatiotemporal perceptual representation, comprising:
a POI context graph structure constructing module configured to construct a POI context structure based on a POI check-in dataset; wherein the POI context graph structure comprises a check-in sequence context graph, a spatial context graph and a spatiotemporal context graph of POIs;
a first sampling module configured to sample the check-in sequence context graph to obtain POI samples;
a first training module configured to train a POI check-in sequence embedding model in a brain-inspired spatiotemporal perceptual embedding model based on the POI samples by unsupervised learning; wherein the POI check-in sequence embedding model is configured to extract a POI sequence representation vector;
a second sampling module configured to perform sampling on the spatial context graph and the spatiotemporal context graph to obtain a spatial POI samples and spatiotemporal POI samples and generate a POI check-in time matrix;
a second training module configured to train a spatiotemporal embedding model in the spatiotemporal perceptual embedding model based on the spatial POI samples, the spatiotemporal POI samples and the POI check-in time matrix by unsupervised learning; wherein the spatiotemporal embedding model is configured to extract a POI spatiotemporal union representation vector comprising a spatial embedding representation vector and a spatiotemporal embedding representation vector;
a combining module configured to combine the POI sequence representation vector and the POI spatiotemporal union representation vector into a POI spatiotemporal perceptual representation vector; and
a third training module configured to, training, based on the POI spatiotemporal perceptual representation vector, a recurrent neural network recommender; and to recommend a next POI through the trained recurrent neural network recommender.
